(19) United States
(12) Patent Application Publication
(10) Pub. No.: US 2013/0341961 A1
(43) Pub. Date: Dec. 26, 2013

(54) DOOR FRAME OF A MOTOR VEHICLE DOOR

(71) Applicant: GM Global Technology Operations LLC, Detroit, MI (US)

(72) Inventors: Erol MORI, Frankfurt (DE); Bayram ERDAL, Ruesselsheim (DE); Michael HORNECK, Ruesselsheim (DE)

(21) Appl. No.: 13/919,208

(22) Filed: Jun. 17, 2013

(30) Foreign Application Priority Data
Jun. 19, 2012 (DE) 10 2012 012 110.5

(51) Int. Cl. B60J 5/04

(52) U.S. Cl. CPC B60J 5/04
USPC 296/146.2; 49/452; 29/428

(57) ABSTRACT

A window guide for a motor vehicle door, a door frame for a motor vehicle, a motor vehicle with at least one motor vehicle door, and a method for the assembly of a motor vehicle door are provided. A window guide for a motor vehicle door includes a guide element suitable for arrangement on a door frame and a positioning insert connected to the guide element. The positioning insert can be brought into engagement with at least one reference structure formed on the door frame. The positioning insert comprises at least one positioning element for the accurately positioned alignment of an attachment part that can be arranged on the door frame.

### CROSS-REFERENCE TO RELATED APPLICATION

This disclosure claims priority to German Patent Application No. 10 2012 012 110.5, filed Jun. 19, 2012, which is incorporated herein by reference in its entirety.

### TECHNICAL FIELD

The technical field relates to a door frame of a motor vehicle door and to a window guide that can be arranged on the door frame for a lowerable window pane. In addition, the technical field relates to a motor vehicle door and to a motor vehicle equipped therewith.

### BACKGROUND

Lowerable window panes of motor vehicle doors are typically guided in a lateral pane or window guide. To this end, the part of a motor vehicle door comprising the corresponding window recess comprises a window guide mostly formed rubber-elastically which is arranged on the door shell, typically on corresponding inner door or outer door panels.

Furthermore, various further attachment parts such as trim panels have to be arranged and fastened accurately positioned on the door shell.

Thus, a frame trim panel for a window frame of a motor vehicle is known for example from DE 10 2009 058 128 A1, wherein initially a trim panel is screwed to a door shell on at least one fastening point. Following this, the trim panel is connected to a guide channel provided for the pane, before a frame panel comprising the trim panel and the guide channel is screwed to the door shell. Alternatively, it can be provided here to initially connect the trim panel to the guide channel and subsequently screw the frame panel comprising the trim panel and guide channel to the door shell.

Other fastening concepts however provide to arrange an elastically-formed window guide directly on the door shell. The door shell to this end can comprise a predetermined reference structure, with respect to which the window guide is to be aligned on the door shell accurately positioned and fastened. A trim panel which is visible from the outside likewise has to be arranged separately on the door shell in this case.

Through unavoidable manufacturing and assembly tolerances of the individual components which have to be connected for example in the region of an upper door node, different gap dimensions between window guide and trim panel can develop for example.

It is at least one object herein therefore to provide a door frame which is improved with respect to its positioning and assembly accuracy, whose window guide and trim panel can be assembled as easily as possible and accurately positioned. Inevitable component tolerances, in particular in the region of the door shell, are to have a far lesser effect in this case on the development of possibly visible gap dimensions and assembly tolerances than in the past. In addition, other objects, desirable features and characteristics will become apparent from the subsequent summary and detailed description, and the appended claims, taken in conjunction with the accompanying drawings and this background.

### SUMMARY

In accordance with an exemplary embodiment, a window guide for a motor vehicle door comprises a guide element that can be arranged on a door frame and a positioning insert that can be connected to the guide element. The positioning insert is preferably integrated in the guide element and makes possible an accurately positioned alignment and positioning of the guide element on the door frame or on the door shell. The positioning insert in this case can be brought into engagement with at least one reference structure formed on the door frame. The positioning insert furthermore comprises a positioning element for an attachment part to be arranged on the door frame.

The positioning element serves for the alignment and positioning of the attachment part with respect to the reference structure provided on the door frame side. Here, the positioning element can exclusively serve for the positioning and alignment of the attachment part, which can be arranged on the door frame separately and independently of the positioning insert and fastened thereto.

Since the positioning insert is connected to the guide element of the window guide, preferably integrated in the latter and since the positioning insert furthermore provides a positioning element for the attachment part, an accurately fitting arrangement of the attachment part with respect to the window guide or to its window element can be provided by the positioning insert, wherein the window guide as well as the attachment part however can be each individually and separately connected to the door frame.

In this way, any component and assembly tolerances in the region of the door frame or of the door shell can be offset in a far better manner Any gap dimension between the attachment part and the window guide or its guide element can be reduced to a minimum.

According to an exemplary embodiment, the positioning insert comprises a pin for inserting in an elongated hole of the reference structure of the door frame aligned in vehicle vertical direction. Seen in vehicle longitudinal direction (x), the pin has an extent which corresponds to the corresponding clear width of the elongated hole. By means of inserting or engaging the pin in the elongated hole formed on the door frame side, the positioning insert and thus also the window guide altogether with respect to at least one space direction can be arranged accurately positioned on the door frame in particular with respect to the vehicle longitudinal direction (x) and suitably fixed in position.

In an alternative embodiment, the positioning insert comprises a corresponding elongated hole while a pin or assembly pin is formed on the door frame side or door shell side.

In any case, the elongated hole formed on the door frame makes possible displaceability of the pin and thus of the positioning insert in longitudinal direction of the elongated hole, consequently in vehicle vertical direction (z). Here it is provided in particular that the guide element of the window guide can be separately arranged on the door frame, in particular on an upper flange of the door frame. Thus, the guide element for example formed as rubber-elastic profile element can be fitted onto an upper flange portion of the door frame for example extending in vehicle transverse direction (y).

According to a further embodiment, the positioning insert comprises an elongated hole aligned in vehicle vertical direction (z). This is formed for mounting a protrusion of the reference structure on the body side. The extent of the reference structure on the body or door frame side in vehicle longitudinal direction (x) in this case corresponds to the clear width of the elongated hole provided on the positioning insert. In this regard, the positioning insert can mount the protrusion of the reference structure with its elongated hole and because of this, based on the vehicle longitudinal direction (x), be arranged accurately positioned on the door frame and correspondingly fixed in position.

Since it is perfectly possible that the position of the upper flange of the door frame can vary within certain manufacturing and assembly tolerances, the reference structure provided on the door frame side or positioning insert side for fixing and positioning the positioning insert comprises a corresponding elongated hole. Thus, the positioning insert for example can be fastened on the door frame at a variable height (z). In that the positioning insert furthermore provides a positioning element for the attachment part, it can transfer tolerances on the door frame side in corresponding manner to the position of the attachment part.

Thus, by means of the positioning element, a position of the window guide and of the positioning insert varying for example in vehicle vertical direction (z) due to tolerance can be transferred to the position of the attachment part largely undistortedly, 1:1 in a manner of speaking. By means of the positioning insert, an always constant and in particular dimensionally stable mutual alignment and arrangement of window guide and attachment part on the door frame can be achieved in this regard.

In a further embodiment, the positioning element of the positioning insert comprises a shank substantially extending in vehicle transverse direction (y). This shank comprises a mounting for a fastening element that can be connected to the attachment part. The fastening element provided for fastening the attachment part on the door frame, for example in the form of a screw, is matched accurately fitting the positioning element with respect to its size and geometry. The shank diameter of the positioning element is formed for as play-free as possible an assembly and mounting of the corresponding fastening element, in particular a screw. In this regard, the position of the positioning element of the positioning insert formed as a shaft defines a transfer of the reference structure provided on the door frame side for the accurately positioned connection and fastening of the attachment part on the door frame.

The positioning element, in particular the shank, in this case defines in particular an alignment of the fastening element in the plane formed by vehicle longitudinal direction (x) and vehicle vertical direction (y), while the fastening element for the attachment part enters into direct engagement with the door frame, directly fastening the attachment part on the door frame.

According to a further embodiment, the pin of the positioning insert and its shank, with respect to the longitudinal direction of the guide element, are formed on the positioning insert spaced from one another. Pin and shank however can also be spaced from one another with respect to the vehicle vertical axis (z). The mutual position and the spacing as well as the alignment of pin and shank with respect to one another can be adapted as required to the respective installation space requirements in the region of the door.

The engaging of the pin in the elongated hole on the door frame side positions the positioning insert with respect to the door frame. The positioning insert transfers that position or the reference structure provided on the door frame side to a corresponding position of the positioning element for the accurately fitting and positioning arrangement of the attachment part with respect to the door frame and/or with respect to the positioning insert.

According to another embodiment, the pin and the shank extend in opposite direction away from the positioning insert. In an assembly configuration on the motor vehicle door, pin and shank extend in particular in vehicle transverse direction (y), wherein the shank extends preferably to the outside and the pin preferably in vehicle transverse direction (y) to the inside. Thus it is provided in particular to insert a positioning insert which is connected in advance or in a preconfigured manner to the guide element of the window guide from the outside into the reference structure of the door frame.

The shank or the positioning element then extends viewed in vehicle transverse direction (y) to the outside and in this regard can provide an assembly and positioning aid for the attachment part to be arranged on the door frame. Thus, the length of the shank of the positioning insert can for example function as bearing for the attachment part, which can then be fastened on the door frame at a fixed predetermined and defined spacing in vehicle transverse direction (y).

The length of the positioning element of shaft substantially extending in vehicle transverse direction (y) can, in this regard, fill an intermediate space between the door frame and the attachment part; clamped in between attachment part and door frame in the final assembly state as it were. In this way, the positioning insert with its shank can predetermine the assembly position of the attachment part with respect to the vehicle transverse direction (y).

Furthermore, according to another embodiment, the positioning element can comprise a mounting provided with two lateral cheeks. The mounting in this case is designed for mounting an assembly piece of the attachment part provided with corresponding lateral cheeks. The lateral cheeks of the positioning elements, thus of the positioning insert, typically extend in vehicle transverse direction (y) and in vehicle vertical direction (z).

In this regard, they form stops or lateral enclosures of the assembly piece on the attachment part side. By inserting the assembly piece on the attachment side in the mounting formed on the positioning element, thus between its lateral cheeks, the assembly piece and thus the entire attachment part can be fixed in position with respect to the vehicle longitudinal direction (x) on the positioning element and correspondingly on the positioning insert.

By forming lateral cheeks corresponding to one another both on the positioning element or on the positioning insert as well as on the assembly piece of the attachment part, comparatively large-area mutual bearing surfaces can be created, which in particular make possible a secure mutual arrangement or supporting of positioning insert and attachment part which is stable in the long term and comparatively fixed.

According to a further embodiment, the positioning element or the positioning insert comprises a groove extending in vehicle longitudinal direction (x) and in vehicle transverse direction (y) for mounting an extension of the attachment part or of an extension of the assembly piece of the attachment part corresponding thereto. A groove extending in vehicle longitudinal direction (x) and vehicle transverse direction (y) can bring about a position fixing of the attachment part in vehicle vertical direction (z) and in this regard provide a bearing surface acting in vehicle vertical direction (z) for one or for a plurality of extensions on the attachment part side.

The extension that can be introduced into the groove of the positioning element or of the positioning insert can for example be provided on an outside of a lateral cheek on the assembly piece side and accordingly extend away from the lateral cheek of the assembly piece.

Here, furthermore, in an embodiment, the assembly piece of the attachment part comprises an extension projecting to the outside on each lateral cheek, which can be inserted into a corresponding groove of the positioning element.

The at least one or two extensions of the attachment part projecting away from one another can for example be formed on an upper end portion of the lateral cheeks of the assembly piece on the attachment part side. The assembly piece can furthermore be formed unitarily with the attachment part or be an integral part of the attachment part.

The lateral cheeks of the assembly piece projecting away from the plane of the attachment part can furthermore be interconnected via a wall portion provided with a through-opening. The wall portion in this case can in particular function for the mounting of a counterpart fastening element interacting with a fastening element.

The counterpart fastening element can for example comprise a thread insert or a sheet metal thread formed strap-like, which can interact with a fastening element comprising a fastening screw. Here, the wall portion extending between the lateral cheeks of the assembly piece can extend approximately parallel to the surface geometry of the attachment part itself

That wall portion however is arranged offset to the surface of the attachment part. In this way, the intermediate space formed by attachment part and wall portion can function for mounting the fastening element and/or a counterpart fastening element interacting therewith.

According to a further embodiment, the positioning insert is formed unitarily. It is, in particular, produced from a plastic and can be formed for example as a shape-retaining casting, in particular as an injection molding. The positioning insert can for example comprise polyamide (PA), polypropylene (PP) or shape-retaining and dimensionally stable plastics comparable to these. The positioning insert can thus be produced in mass production comparatively cost-effectively. Through its unitary or one-piece configuration, its pin and its shank formed as a positioning element are likewise connected unitarily and accordingly in a dimensionally stable manner.

According to another embodiment, the positioning insert is integrated in the guide element preferably formed rubber-elastically, wherein the guide element can be fitted onto a flange on the door frame side and by means of the positioning insert can be arranged on the door frame, at least with respect to the vehicle longitudinal direction (x) accurately positioned to the reference structure. The positioning insert is preferably embedded in the guide element. Depending on the configuration of the guide element, the positioning insert is for example vulcanized into the latter. The positioning insert and the guide element are advantageously non-detachably and permanently connected to one another.

According to a further embodiment, a door frame for a motor vehicle is provided. The door frame forms a door shell and comprises at least one outer panel enclosing a window recess at least in regions, and a window guide as described before, which is arranged accurately positioned on the outer panel by means of the positioning insert.

According to another embodiment, the door frame comprises at least one outer panel and one inner panel in the region of an upper frame corner, which is provided on an end of the door frame facing away from the door hinge. The outer panel and inner panel in this case comprise flange portions which correspond to one another and are connected to one another. Those flange portions are provided in particular in an upper region adjoining the frame corner. The two flange portions approximately project in vehicle transverse direction (y) and are interconnected in vehicle vertical direction (z) overlapping one another in regions or adjoining one another directly.

Typically, the outer panel and the inner panel are welded together, for example spot-welded together, by way of the flange portions which come to lie on top of one another or come to bear against one another.

The two flange portions of inner panel and outer panel in this case form a common flange, which is formed for mounting, in particular fitting or sliding-on, a guide element of the window guide formed in the manner of a profile element. Since the guide element is non-detachably provided with a positioning insert, the height or varying position of the flange in vehicle vertical direction (z), which can by all means vary within predetermined manufacturing and assembly tolerances, predetermines the corresponding z-position of the positioning insert and thereby also the z-position of the attachment part to be aligned on the positioning insert.

According to a further embodiment, at least the outer panel for forming the reference structure already described in connection with the window guide includes an elongated hole substantially extending in vehicle vertical direction (z). The elongated hole of the outer panel serves for mounting the pin provided on the positioning insert, which can be displaceably mounted in the elongated hole merely in vehicle vertical direction (z), consequently in the longitudinal direction of the elongated hole. The extent of the elongated hole in vehicle longitudinal direction (x) is thereby adapted in an accurately fitting manner to the size or the diameter of the pin.

By inserting the pin of the positioning insert into the elongated hole formed on the frame side or on the outer panel side, the guide element, thus the entire window guide, can be aligned on the door frame with respect to the vehicle longitudinal direction (x).

According to an alternative embodiment, the outer panel for forming the reference structure comprises a protrusion substantially extending in vehicle transverse direction (y). The protrusion in this case can be formed in particular as a sheet metal strap, which extends approximately parallel to the surface normal of an outer door panel. A strap of the outer door panel projecting to the outside, i.e. in vertical transverse direction (y) to the outside, in this case can be arranged furthermore directly adjoining a through-opening of the outer door panel. In particular, the through-opening to be provided in the outer door panel can be provided by bending the strap forming the reference structure up or down.

Within the scope of the assembly of the positioning insert on the door frame, the strap-like extension of the reference structure can come to lie in the elongated hole of the positioning insert and thus displaceably fix the positioning insert in vehicle vertical direction (z) on the door frame with respect to the vehicle longitudinal direction (x).

According to an exemplary embodiment, the further attachment part to be arranged on the door frame is formed as a trim panel and can be arranged on the outer panel and connected to the outer panel. The trim panel can be fastened to the outer panel by a fastening element penetrating the outer panel and the shank of the positioning insert. The shank of the positioning insert in this case predetermines an alignment and positioning of the fastening element both in vehicle vertical direction (z) as well as in vehicle longitudinal direction (x).

Since the positioning insert is non-detachably connected to the window guide, gap dimensions which are always the same are obtained between the window guide and the trim panel. The attachment part for example formed as a trim panel is aligned with respect to the window guide in z-direction and x-direction by way of the positioning element formed as a shank. It can also be fastened furthermore directly to the outer panel for example in a bracing manner by the fastening element provided separately.

According to a further embodiment, the attachment part, in particular the trim panel, supports itself on the positioning insert in vehicle transverse direction (y), in particular on its shank, projecting to the outside in vehicle transverse direction (y). The extent of the length of the shank thus predetermines a position of the attachment part with respect to the vehicle transverse direction (y) relative to the outer panel. The positioning element in this case functions as a kind of spacer between outer panel and attachment part in vehicle transverse direction (y).

According to another embodiment, the outer panel, in the region of the elongated hole, is stamped facing away from the inner panel, wherein the inner panel and the outer panel are arranged at least in regions in an overlapping manner spaced from one another. Through a stamping facing away from the inner panel, a curvature or pocket-like depression can be formed in the outer panel, which can serve for mounting the pin of the positioning insert to be inserted in the elongated hole. Because of this, a clear spacing of the inner and outer panel with respect to the vehicle transverse direction (y) can be reduced.

Deviating from this, it is conceivable, furthermore, depending on the concrete configuration of the door frame, that the outer panel adjoining the positioning insert which comes to bear thereon, is substantially formed flat and/or adapted to a concrete shaping, with respect to the outer contour of the positioning insert.

Finally, according to a further independent embodiment, a motor vehicle is provided, which comprises at least one previously described door frame with a likewise previously described window guide.

According to a further embodiment, a method for the assembly of a motor vehicle door is provided. In a first step a door frame with a reference structure is provided. Following this, a previously described window guide is arranged on the door frame subject to the use of a positioning insert formed thereon and positioned and aligned with respect to the reference structure. Following this, a further attachment part, in particular a trim panel, is then fastened to the door frame, wherein a positioning element formed on the positioning insert is used for alignment and positioning of the attachment part.

The method provided in this regard makes possible an accurately fitting and positioned assembly of the attachment part to be arranged on a door frame, which despite a direct fastening on the door frame or on the door shell can be aligned and positioned relative to a further attachment part formed as window guide and which can be likewise directly arranged on the door frame.

Further features and method steps are obtained perforce from the shaping and mutual arrangement of the door frame and its attachment parts, wherein all functional relationships described previously and also in the following between individual components can be interpreted in the sense of an assembly method and vice versa.

### BRIEF DESCRIPTION OF THE DRAWINGS

The various embodiments will hereinafter be described in conjunction with the following drawing figures, wherein like numerals denote like elements, and wherein:

FIG. 1 is a schematic view of a motor vehicle door;

FIG. 2 is a perspective and enlarged representation of an upper door node viewed from the inside;

FIG. 3 is a perspective and enlarged representation of the door node according to FIG. 2 viewed from the outside;

FIG. 4 is an isolated perspective representation of a positioning insert;

FIG. 5 is a further perspective representation of the positioning insert of FIG. 4;

FIG. 6 is a cross-sectional representation in the x-y plane through a door frame;

FIG. 7 is a sectioned perspective representation corresponding to the cross section according to FIG. 6;

FIG. 8 is a further cross-sectional representation of the door frame in the x-z plane;

FIG. 9 is sectioned perspective representation of the door frame corresponding to FIG. 8;

FIG. 10 is a perspective and enlarged representation of an upper door node according to a further embodiment;

FIG. 11 is an isolated perspective representation of a positioning insert according to a further embodiment;

FIG. 12 is a further perspective representation of the positioning insert according to FIG. 11;

FIG. 13 is an inside view of an attachment part provided with an assembly piece according to an embodiment;

FIG. 14 is a cross section along the y-z plane through the door frame;

FIG. 15 is a cross section in the x-y plane of the door frame; and

FIG. 16 is a further cross section displaced in vehicle longitudinal direction (x) with respect to the cross-sectional plane of FIG. 14 through the door frame in the y-z plane.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

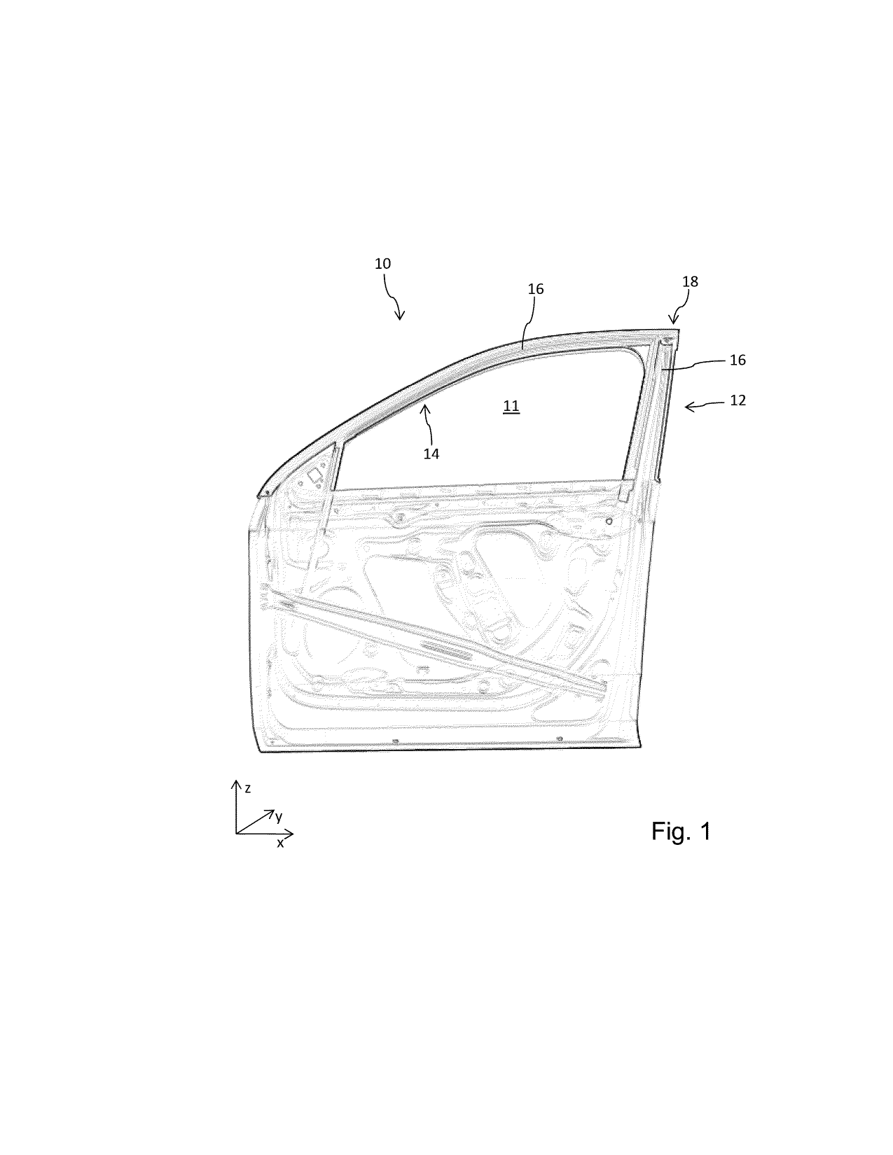

In an exemplary embodiment, the motor vehicle door 10 shown in FIG. 1 comprises a door frame 12 with a structure enclosing a window pane or window recess 11. In the region which is closed in a frame-like manner and comprises the window recess 11, a window guide 14 is provided, which, comprising at least one soft-elastic material, can be arranged on the surrounding door frame 12.

For example, the rubber-elastic window guide 14 formed in the manner of a guide profile with a guide element 16, which can be placed about the window recess 11 profile-like, can be fitted onto a flange 30 of the door frame 12 approximately projecting in vehicle transverse direction (y) at least in the region of a frame corner 18 shown on the top right in FIG. 1.

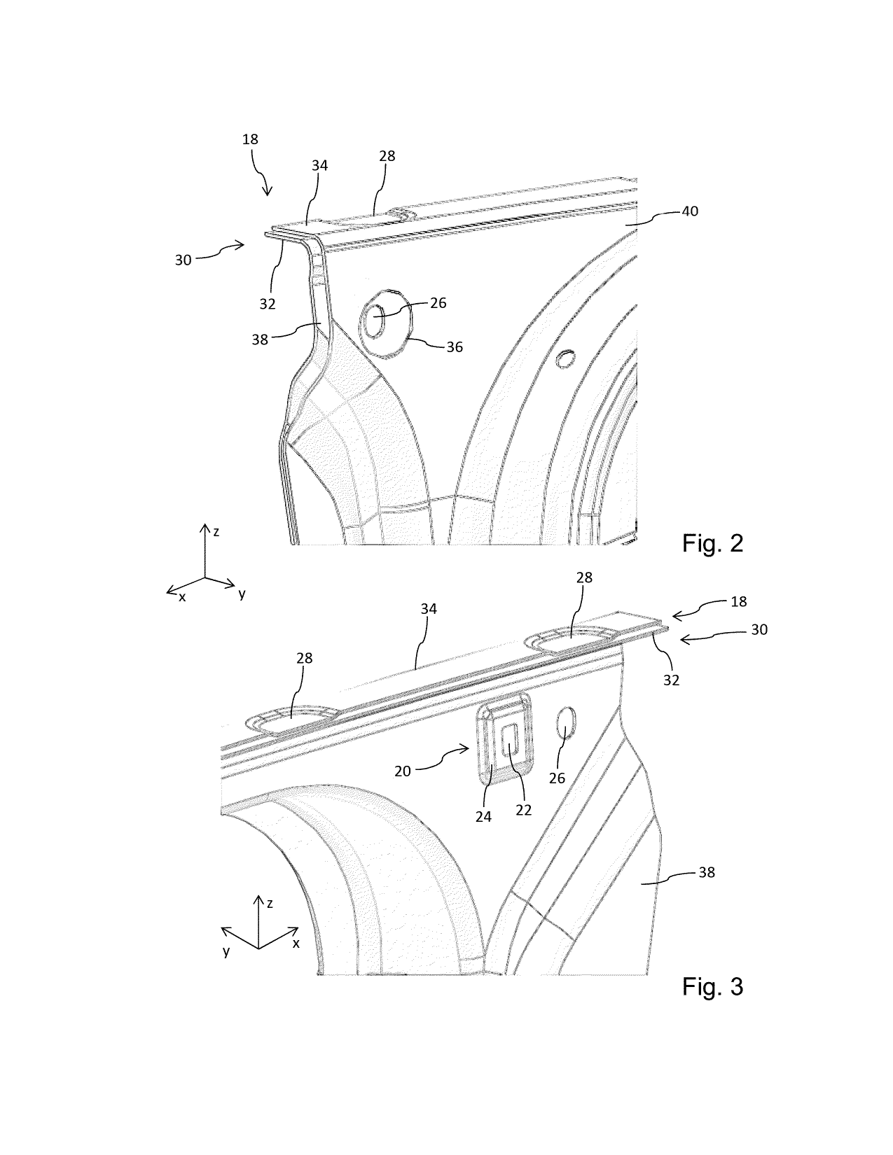

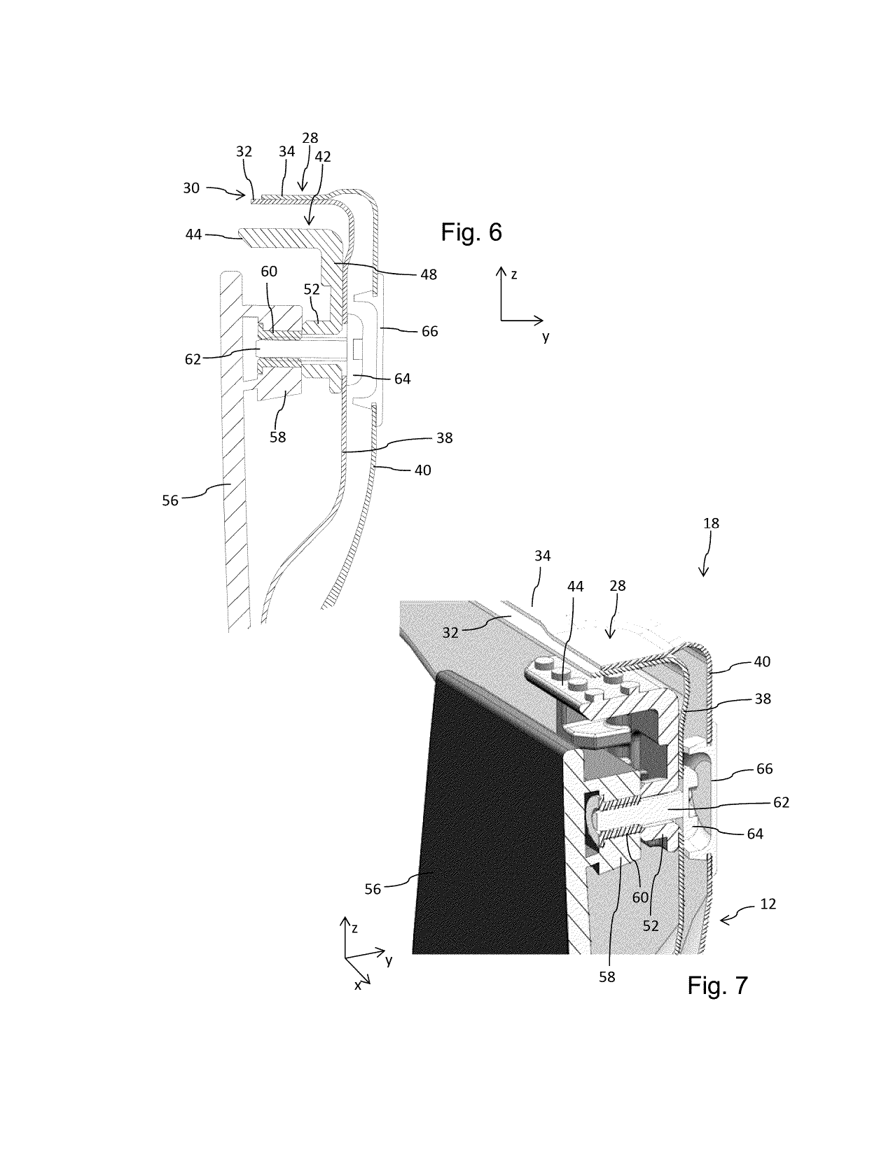

The top right frame corner 18 facing away from the door hinge, provided on the left in FIG. 1, is shown separately in an enlarged perspective representation in FIGS. 2 and 3. In an embodiment, the frame corner 18, thus the door frame 12, has a two-shell structure with an inner panel 40 and with an outer panel 38, which is substantially arranged covering the inner panel 40. For fastening a further attachment part for example formed as a trim panel shown in FIG. 6, the outer panel 38 and the inner panel 40 each have a through-opening 26, 36, which corresponding to the representation according to FIG. 2, come to lie overlapping one another.

Being passed through those through-openings 26, 36, as shown in FIG. 6, the attachment part 56 can be connected to the outer panel 38. A corresponding fastening element 62 formed for example in the form of a screw can engage in this case in a thread insert 60 arranged in a mounting 58 of the attachment part 56 and come to bear against an inside of the outer panel 38 by tightening with a radially widened screw head 64. The attachment part 56 can thus be directly screwed to the outer panel 38.

In an embodiment, inner panel 40 and outer panel 38 each comprise a flange portion 32, 34 shown in FIGS. 2, 3 and 6, wherein the upper flange portion 34 of the inner panel 40 in the region of a stamping 28 which is directed to the inside or downwards can lie on the flange portion 32 of the outer panel 38 which is located below and aligned approximately parallel thereto. In the region of that support, the two flange portions 32, 34 can be directly interconnected to form a common flange 30. They are preferably welded together or otherwise materially connected to one another for example through gluing.

The position of the common flange 30 resulting because of this can by all means vary according to the manufacturing and/or joining tolerances of inner panel 40 and outer panel 38 in the direction of the vehicle vertical axis (z). Since the flange 30 additionally provides a fastening point for the window guide 14, in particular for its profile-like guide element 16, different z-positions of the guide element 16, thus of the entire window guide 14 relative to the door frame 12 can result depending on component tolerances.

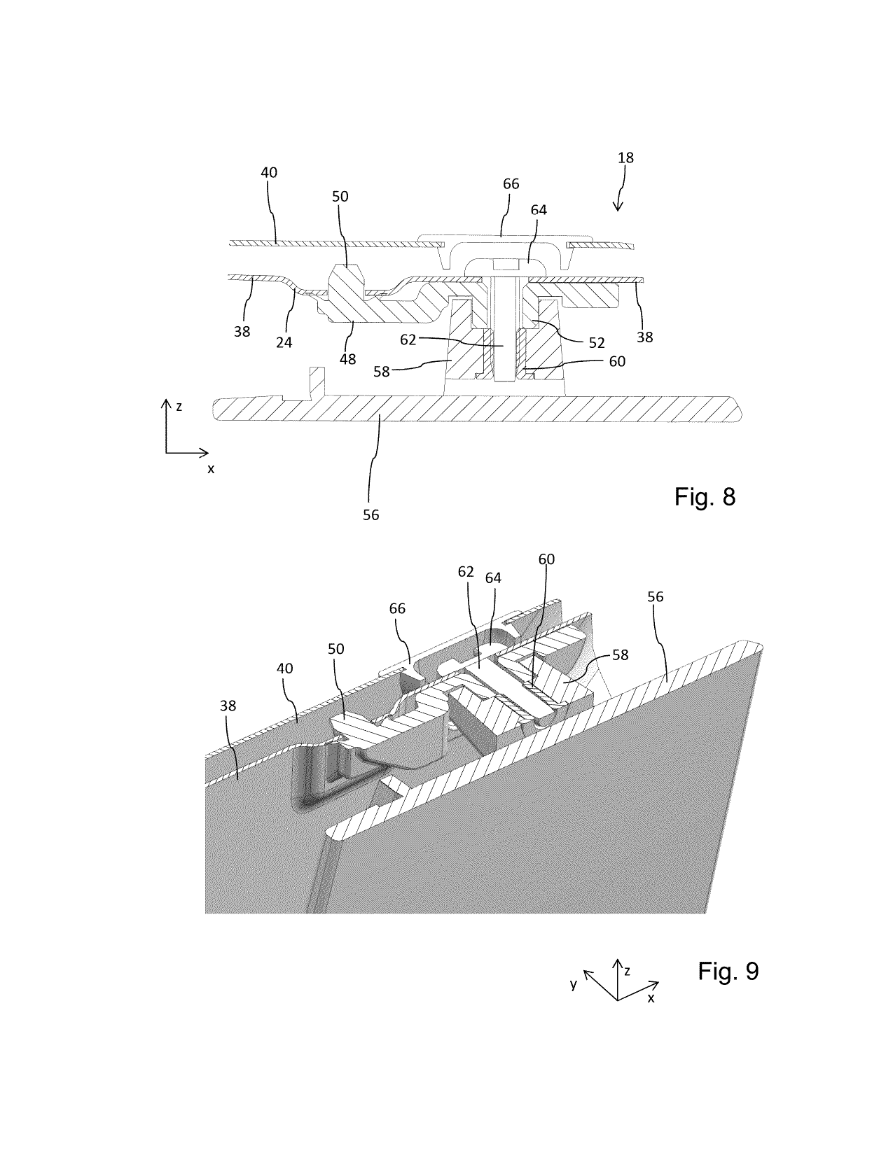

To maintain predetermined maximum tolerances, in particular with respect to the components that are visible from the outside, in an embodiment, the outer panel 38, as shown in FIG. 3, comprises an elongated hole 22 which is substantially aligned in vehicle vertical direction (z) and displaced approximately in vehicle longitudinal direction (x) towards the through-opening 26. The elongated hole 22, as is evident in FIG. 8, is provided in the region of a stamping 24 facing to the outside facing away from the inner panel 40. The stamping 24 as well as the through-opening 26 as well as the elongated hole 22 in this case can be production-rationally introduced into the outer panel 38 in a single operation.

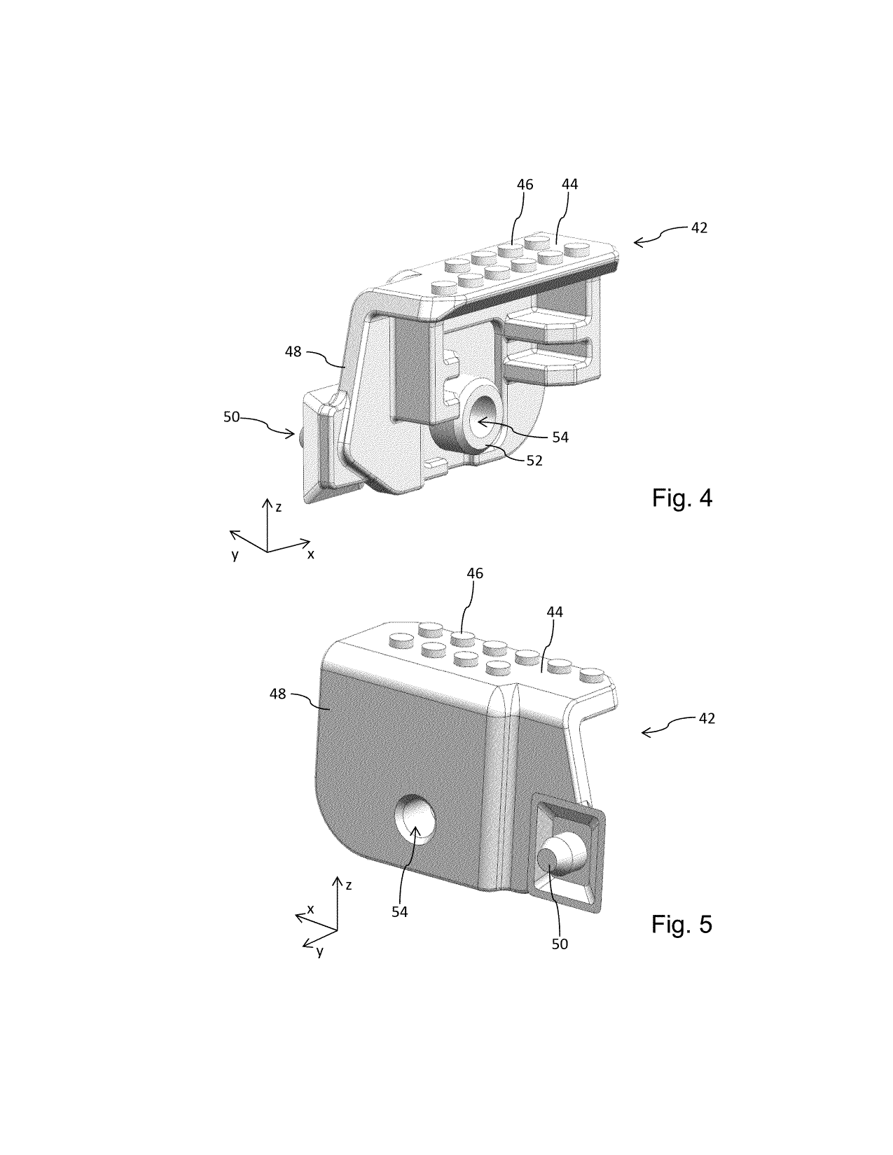

In another embodiment, the elongated hole 22 provided in the outer panel 38 serves for forming a reference structure 20 provided on the outer panel 38 for the accurately fitting and accurately positioned assembly of the window guide 14. The window guide 14 to this end comprises a positioning insert 42 which is shown in an isolated manner in FIGS. 4 and 5, which is preferably incorporated in the guide element 16 of the window guide 14, in particular vulcanized into a rubber-elastic guide element 16. The positioning insert 42 comprises an upper flange portion 44 provided with cleats 46, by means of which the positioning insert 42 is incorporated in the guide element 16. The guide element 16 which is formed profile-like and extends along the flange 30 is not explicitly shown in the FIGS. 2 to 9 for the sake of better representability of the remaining components.

From the upper flange portion 44 of the positioning insert 42 a lateral cheek 48 projects downwards, on which a pin 50 projecting to the inside, in vehicle transverse direction (y) is formed, according to a further embodiment. The pin 50 provided with an insertion chamfer has an outer diameter which corresponds to the clear cross section of the elongated hole 22 in vehicle longitudinal direction (x). By inserting the pin 50 in the elongated hole 22, as shown in FIG. 8, the positioning insert 50 and with it the window guide 14 is fixed in position on the door frame 12 with respect to the vehicle longitudinal direction (x).

The pin 50, however, is moveable in the direction of the elongated hole 22 in vehicle vertical direction (z) with respect to the door frame 12 and comes to lie against the outer panel 38 corresponding to a configuration and position of the flange 30 which varies in the direction of the vehicle vertical axis (z).

The cheek 48 of the positioning insert, laterally offset with respect to the pin 50, comprises a positioning element 52 projecting in the opposite direction, consequently to the outside, for example in the form of a shank 52 with a through-opening 54. The positioning element 52 serves for the accurately positioned arrangement of the already described fastening element 62 with respect to the vehicle vertical direction (z) as well as also the vehicle longitudinal direction (x). In this regard, that shaft 52 can reposition the reference structure 20 formed on the outer panel 38 for the accurately positioned arrangement of the attachment part 56 into a fastening point for the attachment part 56 spaced therefrom.

The positioning element 52 or the shank additionally has an extent with respect to the vehicle transverse direction (y) which is predetermined in a fixed manner, so that in another embodiment, for example shown in FIGS. 6 and 8, the fastening element 62 can be screwed to the attachment part 56 in such a manner that a mounting 58 of the attachment part 56 can come to bear against a free end of the shank 52 directed to the outside in a supporting manner. The length of the shank 52 thus predetermines an assembly reference for the attachment part 56 in vehicle transverse direction (y).

After completed assembly of the window guide 14 about the attachment part 56, the through-opening 36, which is provided on the inner panel 40 and purely formed for assembly purposes, can be provided with a covering 66.

In the exemplary embodiment according to FIGS. 1 to 9 shown here, both the window guide, at least based on vehicle longitudinal direction (x) can be fastened accurately positioned on the door frame 12 because of the positioning insert provided on the window guide 14. According to an arrangement of the window guide 14 with respect to the vehicle vertical direction (z) which varies subject to maintaining predetermined tolerances, the further attachment part 56 to be directly connected to the outer door panel 38 can be positioned by the positioning insert 42 and its positioning element 52 directly formed thereon and arranged on the door frame 12 with respect to the variable position of the window guide 14 while maintaining a same gap dimension in each case. Here, the positioning element 52 of the positioning insert 42 furthermore forms a defined bearing with respect to the assembly of the further attachment part 56 in vehicle transverse direction (y).

In this regard, both the window guide 14 as well as at least one further attachment part 56 can be aligned on one and the same reference structure 20 of the door frame 12, in particular on its outer panel, so that unavoidable production tolerances and geometrical deviations of the frame 12, of the window guide 14 as well as of the further attachment part 56 mutually compensate one another as far as possible but are preferably not disadvantageously propagated.

The shown embodiments merely show possible configurations of the invention, to which numerous further versions are conceivable and within the scope of the invention. The shown exemplary embodiments must in no way be interpreted as being restrictive with respect to the scope, the applicability or the configuration possibilities of the invention. The present description merely shows the person skilled in the art a possible implementation of an exemplary embodiment. Thus, a wide range of modifications can be carried out with respect to the function and arrangement of described elements without leaving the scope of protection or its equivalent defined by the following patent claims.

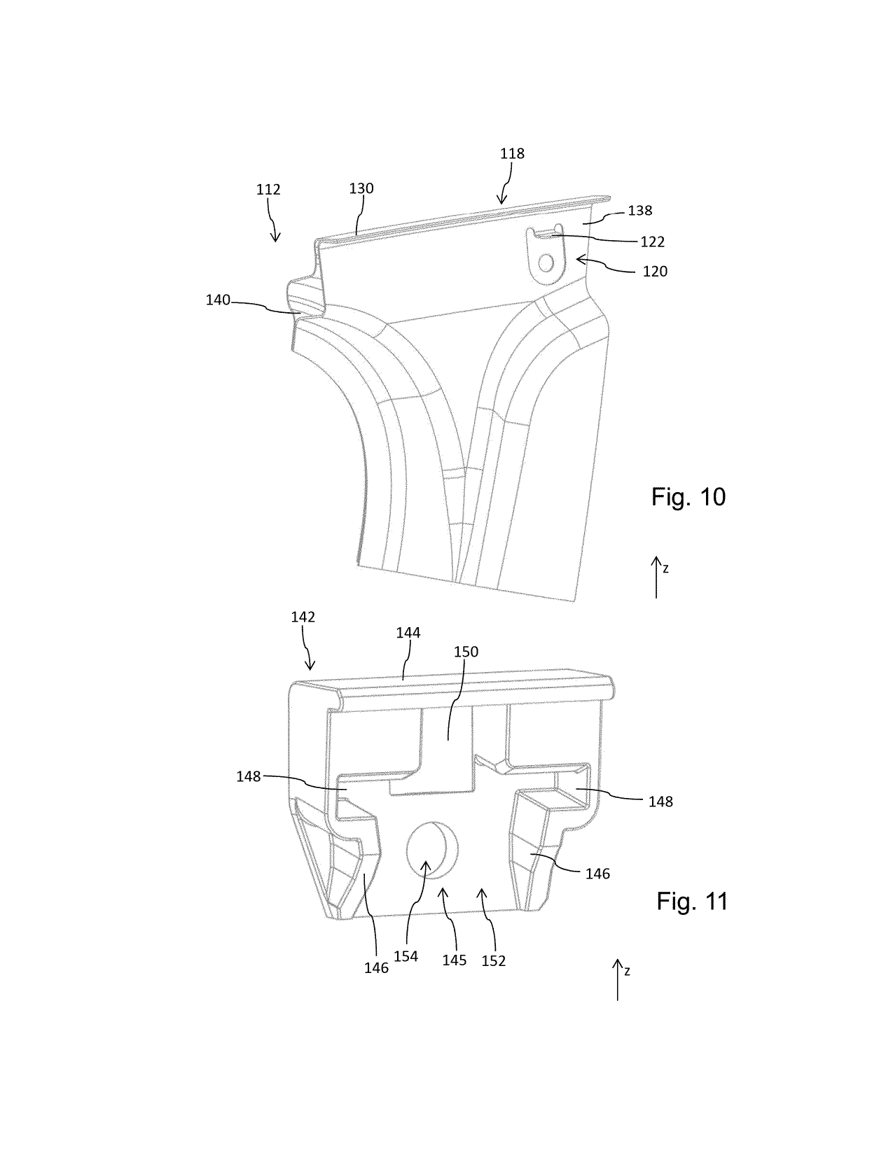

FIGS. 10 to 16 show a further exemplary embodiment of a positioning insert 142 which can be arranged on a door frame 112 with an upper flange portion 144. That positioning insert 142 is typically formed as a plastic injection molding similar to the positioning insert 42 already described in the FIGS. 1 to 9. It is furthermore likewise integrated or embedded in a guide element which is preferably formed in a rubber-elastic manner.

Comparable with the representation according to FIG. 3, FIG. 10 shows a frame corner 118 of a door frame 112 which in its geometrical configuration varies slightly. That door frame 112, which likewise has an upper flange 130, in this case is equally formed also by an outer panel 138 and an inner panel 140.

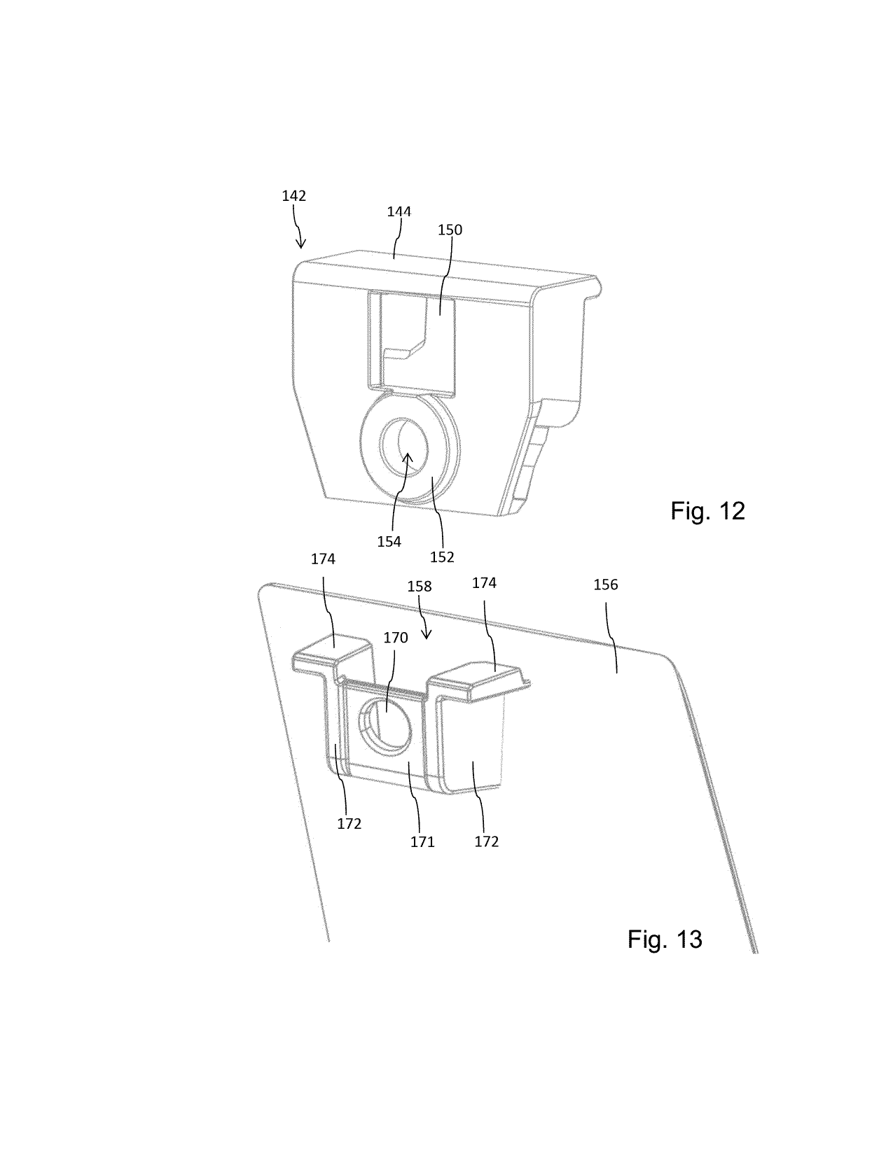

On the outer panel 138, a reference structure 120 in the form of a protrusion 122 projecting from the outer panel 138 is formed. The protrusion 122 has a bent-over strap projecting to the outside, in vehicle transverse direction (y). This protrusion 122 can be inserted into a through-opening 150 formed in the manner of an elongated hole of a positioning insert 142 shown isolated in the FIGS. 11 and 12. The width of the through-opening 150 in vehicle longitudinal direction (x) in this case corresponds to the width of the protrusion 122 provided on the door frame side. In that the protrusion 122 projects into the through-opening 150 of the positioning insert 142 corresponding thereto, the positioning insert 142 is fixed in position on the door frame 112 with respect to the vehicle longitudinal direction (x). The elongated hole-like configuration of the through-opening 150 in vehicle vertical direction (z) however makes possible a tolerance-compensating displacement or assembly of the positioning insert 142.

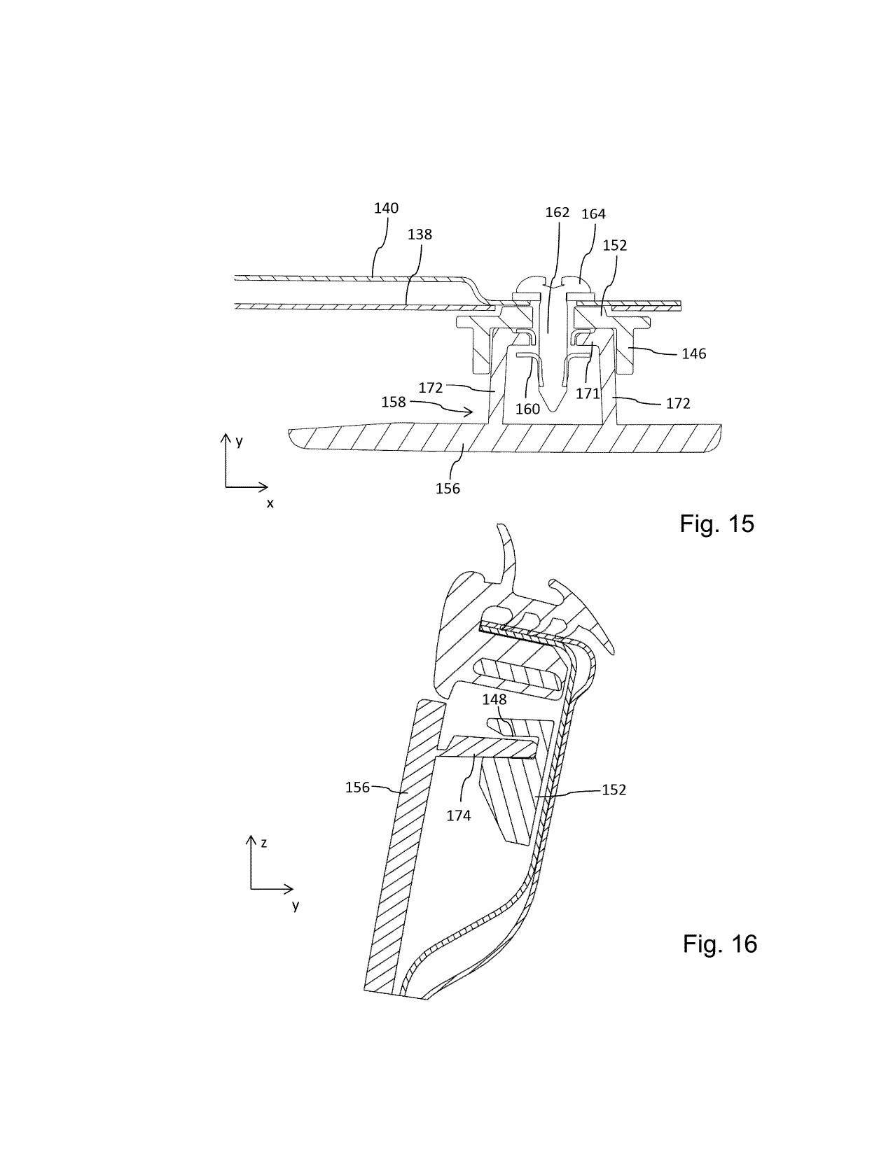

Similar to the positioning insert 42, the positioning insert 142 also comprises a positioning element 152 or a positioning structure with a through-opening 154. On a side in the finally assembly state facing the inner panel 140, the positioning element 152 comprises a bulge-like elevation, by means of which the positioning element 152 supports itself on the inner panel 140 in vehicle transverse direction (y), as is shown in cross section according to FIG. 15.

Located opposite, i.e. facing away from the outer panel 138 or the inner panel 140, the positioning element 152 comprises a mounting 145 shown in FIG. 11 for an assembly piece 158 of the attachment part 156. The mounting 145 formed on the positioning insert 142 comprises two lateral cheeks 146 which are spaced from one another in vehicle longitudinal direction (x), by means of which lateral cheeks 172 of the assembly piece 158 of the attachment part 156 corresponding thereto can be fixed in position.

As is shown in the final assembly configuration according to FIG. 15 in cross section, the lateral cheeks 172 of the assembly piece 158 of the attachment part 156 are laterally enclosed by the lateral cheeks 146 corresponding thereto of the mounting 145 of the positioning insert 142 or the positioning element 152. In this regard, a fixing of the attachment part 156 on the positioning portion 142, thus on the door frame 112 in vehicle longitudinal direction (x) can take place by means of the lateral cheeks 146, 172 which mutually come to bear.

Furthermore, the assembly piece 158 supports itself on the mounting 145 of the positioning insert 142 also in vehicle transverse direction (y). The two lateral cheeks 172 of the assembly piece 158 with their end faces enter into a direct bearing position with the inside of the mounting 145 of the positioning insert 142 in the manner shown in FIG. 15.

The lateral cheeks 172 of the assembly piece 158 are furthermore directly interconnected with their end portions spaced from the attachment part 156 via a wall portion 171. That wall portion 171 in this case is provided with a through-opening 170 for mounting a fastening element 162 formed for example as a screw. The fastening element 162 furthermore comprises a screw head, by means of which comes to bear against the inside of the inner panel 140 in a supporting and position-fixed manner.

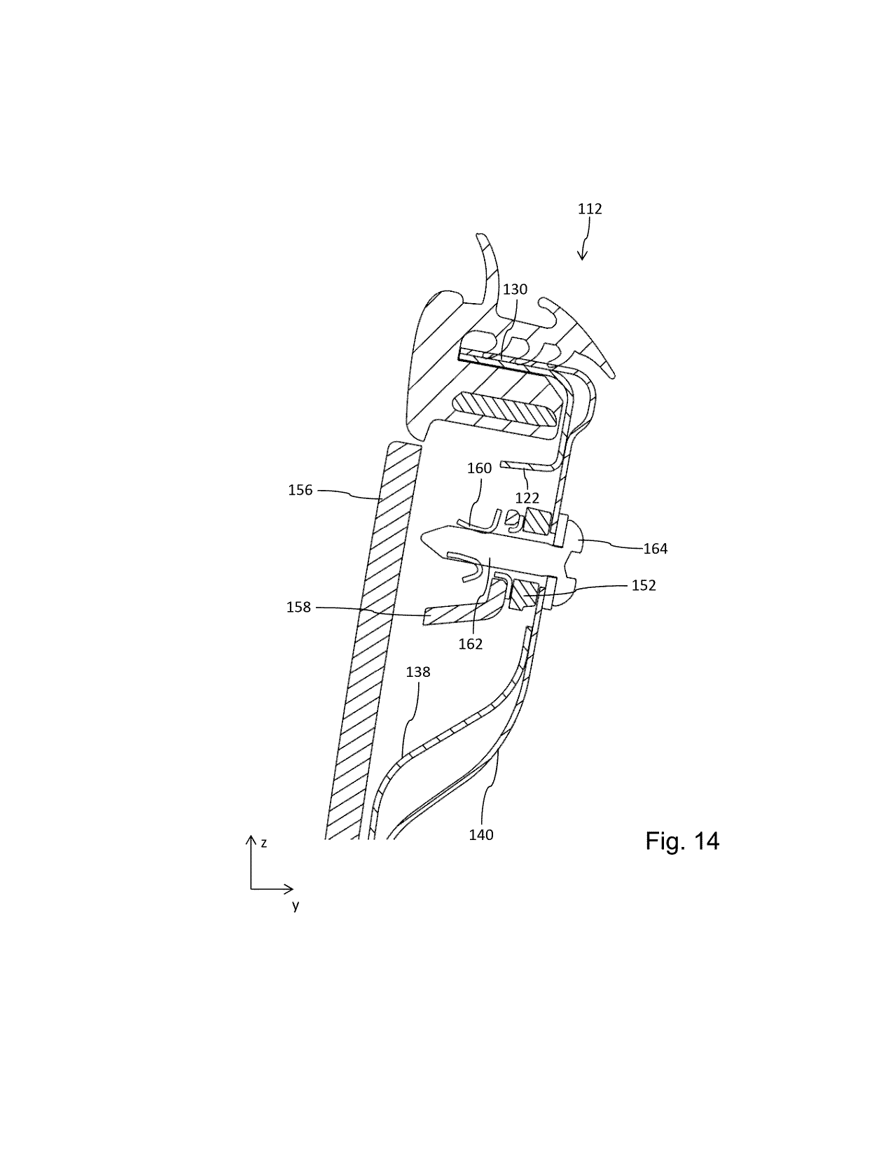

In an embodiment, that wall portion 171 is formed for mounting a counterpart fastening element, for example for mounting a sheet metal thread 160. A sheet metal thread 160 which in FIGS. 14 and 15 is only shown in cross section each, can be formed in particular by a formed sheet metal part, which can be fitted onto the wall portion 171 of the assembly piece 158 and/or which can be inserted, in particular clipped into the through-opening 170 of the assembly piece 158.

The positioning element 152, thus the positioning structure of the positioning insert 142 comprises a groove 148 extending in vehicle longitudinal direction (x) and in vehicle transverse direction (y) each adjoining the lateral cheeks 146. Those grooves 148 in this case are formed for mounting extensions 174 of the assembly piece 158 of the attachment part 156 which correspond thereto and project to the outside. The mentioned extensions 174 extend on the upper end portion of the lateral cheeks 172 of the assembly piece 158 located outside. The extent of the grooves 148 and the extensions 174 corresponding thereto in vehicle vertical direction (z) in this case are dimensioned such that the extensions 174 can be inserted accurately fitting in the grooves 148 corresponding thereto, as is evident from the cross section of FIG. 16.

The extensions 174 which project to the outside wing-like can thus provide a position fixing on the door frame 112 of the assembly piece 158 and the attachment part 156 formed unitarily with the assembly piece 158 with respect to the vehicle vertical direction (z).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A window guide for a motor vehicle door, the window guide comprising:
a guide element suitable for arrangement on a door frame; and
a positioning insert connected to the guide element, which positioning insert can be brought into engagement with at least one reference structure formed on the door frame wherein the positioning insert comprises at least one positioning element for the accurately positioned alignment of an attachment part that can be arranged on the door frame.

2. The window guide according to claim 1, wherein the positioning insert comprises an elongated hole aligned in a vehicle vertical direction (z), which is formed for mounting a protrusion of the reference structure.

3. The window guide according to claim 1, wherein the positioning element comprises a shank substantially extending in a vehicle transverse direction (y) for mounting a fastening element that can be connected to the attachment part.

4. The window guide according to claim 1, wherein the positioning element comprises a mounting comprising two first lateral cheeks, which are formed for mounting an assembly piece of the attachment part corresponding to two second lateral cheeks.

5. The window guide according to claim 4, wherein the positioning element comprises at least one groove extending in a vehicle longitudinal direction (x) and vehicle transverse direction (y) for mounting an extension of the attachment part corresponding thereto.

6. The window guide according to claim 1, wherein the positioning insert is formed unitarily.

7. The window guide according to claim 1, wherein the positioning insert is integrated in the guide element, which can be fitted onto a flange on the a door frame side and can be arranged on the door frame accurately positioned to the reference structure at least with respect to the vehicle longitudinal direction by the positioning insert.

8. A door frame for a motor vehicle comprising:
an outer panel; and
a window guide comprising:
a guide element suitable for arrangement on a door frame; and
a positioning insert connected to the guide element, which positioning insert can be brought into engagement with at least one reference structure formed on the door frame, wherein the positioning insert comprises at least one positioning element for the accurately positioned alignment of an attachment part that can be arranged on the door frame.

9. The door frame according to claim 8, wherein, at least in a region of an upper frame corner, further comprises an outer panel and an inner panel, which comprise flange portions that correspond to one another and are connected to one another.

10. The door frame according to claim 9, wherein the at least one reference structure comprises a protrusion in the outer panel substantially extending in vehicle transverse direction (y).

11. The door frame according to claim 9, wherein the attachment part is a trim panel that can be arranged on the outer panel and that can be fastened on the outer panel by a fastening element penetrating the outer panel and the positioning element.

12. The door frame according to claim 8, wherein the attachment part supports itself on the positioning insert in vehicle transverse direction (y).

13. The door frame according to claim 9, wherein the outer panel is stamped in a region of an elongated hole facing away from the inner panel.

14. A motor vehicle with at least one motor vehicle door, the motor vehicle door comprising:
an outer panel; and
a window guide comprising:
a guide element suitable for arrangement on a door frame; and
a positioning insert connected to the guide element, which positioning insert can be brought into engagement with at least one reference structure formed on the door frame, wherein the positioning insert comprises at least one positioning element for the accurately positioned alignment of an attachment part that can be arranged on the door frame.

15. A method for the assembly of a motor vehicle door, the method comprising the steps of:
providing a door frame with a reference structure;
arranging a window guide comprising:
a guide element suitable for arrangement on the door frame; and
a positioning insert connected to the guide element, which positioning insert can be brought into engagement with the reference structure formed on the door frame, wherein the positioning insert comprises at least one positioning element for the accurately positioned alignment of an attachment part that can be arranged on the door frame;
positioning the window guide with respect to the reference structure by using the positioning insert; and
arranging the attachment part on the door frame subject to using the positioning element formed on the positioning insert.
